(19) United States
(12) Patent Application Publication
(10) Pub. No.: US 2025/0139614 A1
(43) Pub. Date: May 1, 2025

(54) FACILITATING A NON-CUSTODIAL WALLET APPLICATION AT A CLIENT DEVICE

(71) Applicant: NuKey Inc., Henderson, NV (US)

(72) Inventors: George Melika, Henderson, NV (US); Daniel Andrew Kim, Las Vegas, NV (US); Leonardo Cicconi, Los Angeles, CA (US)

(21) Appl. No.: 18/929,383

(22) Filed: Oct. 28, 2024

Related U.S. Application Data
(60) Provisional application No. 63/593,784, filed on Oct. 27, 2023.

(51) Int. Cl. G06Q 20/38; G06Q 20/36; G06Q 20/40

(52) U.S. Cl. CPC G06Q 20/3829; G06Q 20/3674; G06Q 20/4016

(57) ABSTRACT

Methods and systems provide for facilitating a non-custodial wallet application at a client device. In one embodiment, the system: presents, at a client device associated with a user, a user interface for a non-custodial wallet application configured for managing cryptographic keys associated with user-held assets on the client device; establishes a policy threshold condition within the non-custodial wallet to facilitate rule-based control over transactions involving the user-held assets; enables a user of the non-custodial wallet to define and configure rules governing the spending of the user-held assets; verifies the rules independently at both the client device and a server backend; initiates a transaction request involving the user-held assets; transmits the transaction request to the server backend for rule verification; and upon successful authorization, transmits a secure portion of a cryptographic key from the server backend to the client device, the secure portion enabling cryptographic transaction signing.

### CROSS-REFERENCE TO RELATED APPLICATIONS

This application claims the benefit of priority to U.S. Provisional Application No. 63/593,784, filed on Oct. 27, 2023, which is hereby incorporated by reference in its entirety.

### FIELD OF INVENTION

Various embodiments relate generally to digital wallets, and more particularly, to systems and methods for facilitating a non-custodial wallet application at a client device.

### SUMMARY

The appended claims may serve as a summary of this application.

### BRIEF DESCRIPTION OF THE DRAWINGS

The present invention relates generally to digital wallets, and more particularly, to systems and methods for facilitating a non-custodial wallet application at a client device.

The present disclosure will become better understood from the detailed description and the drawings, wherein:

FIG. 1 is a diagram illustrating an exemplary environment in which some embodiments may operate.

FIG. 2 is a diagram illustrating an exemplary computer system that may execute instructions to perform some of the methods herein.

FIG. 3 is a flow chart illustrating an exemplary method that may be performed in some embodiments.

FIG. 4 is a diagram illustrating a user interface for the digital non-custodial wallet application that facilitates rule-based control over transactions involving user-held assets.

FIG. 5 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Cryptocurrencies have gained widespread adoption as digital assets with decentralized and borderless transaction capabilities. In this digital landscape, cryptocurrency wallets serve as essential tools for users to store, manage, and transact with their cryptographic assets. These wallets can be broadly categorized as either custodial or non-custodial. Custodial wallets, typically offered by centralized exchanges, involve third-party control over users' private keys and assets, exposing users to risks of security breaches and loss of control. Non-custodial wallets, on the other hand, empower users to retain sole possession of their private keys, ensuring enhanced security and control over their cryptocurrency holdings.

Current non-custodial wallets primarily function as tools for securely storing private keys, providing access to cryptocurrency holdings on various blockchain networks. Users typically manage their assets through cryptographic key pairs, and transactions are executed by signing them with private keys. However, the existing non-custodial wallet solutions often lack sophisticated rule-based mechanisms for transaction management. Users are often limited to manually initiating transactions without the ability to establish comprehensive rules and conditions governing the spending of their assets. This limitation hampers the customization, security, and control that users seek in their cryptocurrency transactions.

Moreover, the dynamic nature of cryptocurrency markets and the potential for fraud necessitate innovative security measures. Current non-custodial wallets often lack advanced fraud detection and prevention capabilities, leaving users vulnerable to unauthorized or fraudulent transactions. Additionally, the process of securely managing cryptographic keys and executing transactions can be complex and daunting for less technically inclined users, limiting the widespread adoption of non-custodial wallets.

Given these limitations, there is a growing need for a more advanced and user-centric non-custodial wallet solution that addresses the challenges of secure transaction management, rule-based customization, and user-friendly accessibility. This invention seeks to bridge the gap between traditional non-custodial wallet functionalities and the evolving demands of cryptocurrency users, providing an efficient and secure platform for managing cryptographic assets while offering advanced rule-setting capabilities and enhanced transaction security.

In one embodiment, the system: presents, at a client device associated with a user, a user interface for a non-custodial wallet application configured for managing cryptographic keys associated with user-held assets on the client device; establishes, at the client device, a policy threshold condition within the non-custodial wallet to facilitate rule-based control over transactions involving the user-held assets; enables, at the client device, a user of the non-custodial wallet to define and configure rules governing the spending of the user-held assets, the rules including predefined conditions for transaction approval; verifies the rules independently at both the client device and a server backend for the non-custodial wallet application during a transaction initiation process, wherein the server backend hosts verification code for the rules; initiates, at the client device, a transaction request involving the user-held assets, subject to the predefined conditions; transmits the transaction request to the server backend for rule verification, the server backend performing an authorization process based on the rules without signing the transaction; and in response to successful rule verification at the server backend, transmits a secure portion of a cryptographic key from the server backend to the client device, the secure portion enabling cryptographic transaction signing.

Further areas of applicability of the present disclosure will become apparent from the remainder of the detailed description, the claims, and the drawings. The detailed description and specific examples are intended for illustration only and are not intended to limit the scope of the disclosure.

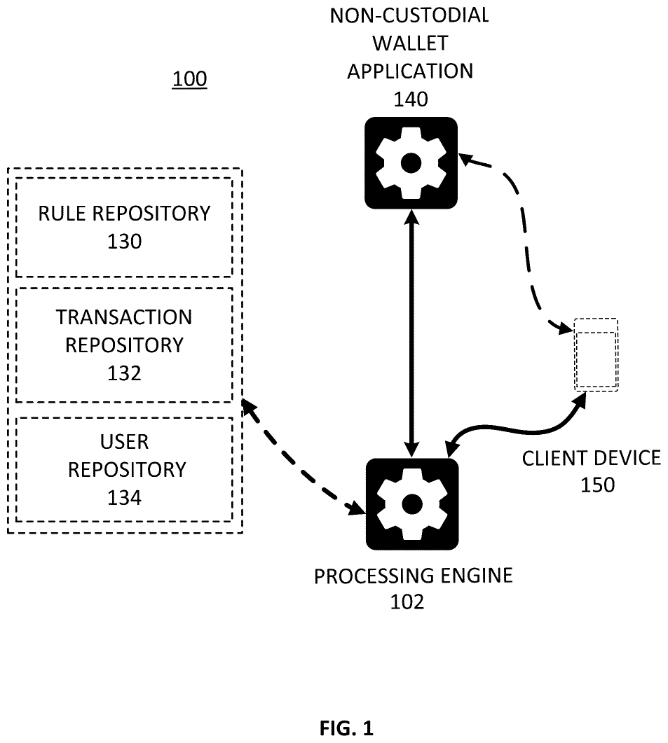

FIG. 1 is a diagram illustrating an exemplary environment in which some embodiments may operate. In the exemplary environment 100, a client device 150 is connected to a processing engine 102 and a non-custodial wallet application 140. The processing engine 102 is connected to the non-custodial wallet application 140, and is optionally connected to one or more repositories and/or databases, including, e.g., a rule repository, a transaction repository, and a user repository. One or more of the databases may be combined or split into multiple databases. The client device 150 in this environment may be a computer, and the non-custodial wallet application 140 and processing engine 102 may be applications or software hosted on a computer or multiple computers which are communicatively coupled via remote server or locally.

The exemplary environment 100 is illustrated with only one client device, one processing engine, and one non-custodial wallet application, though in practice there may be more or fewer additional client devices, processing engines, and/or non-custodial wallet applications. In some embodiments, the client device(s), processing engine, and/or non-custodial wallet application may be part of the same computer or device.

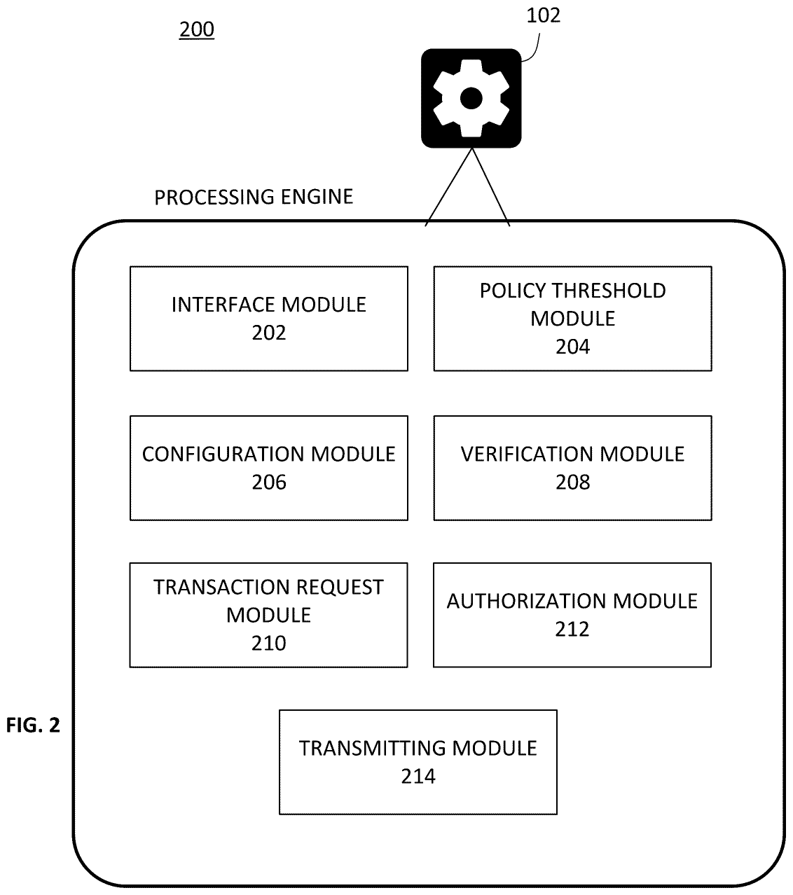

In an embodiment, the processing engine 102 may perform the exemplary method of FIG. 2 or other method herein and, as a result, provide for facilitating a non-custodial wallet application within a client device. In some embodiments, this may be accomplished via communication with the client device, processing engine, non-custodial wallet application, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

FIG. 2 is a diagram illustrating an exemplary computer system that may execute instructions to perform some of the methods herein. An exemplary computer system 200 is shown with software modules that may execute some of the functionality described herein. In some embodiments, the modules illustrated are components of the processing engine 202.

Interface module 202 functions to present, at a client device associated with a user, a user interface for a non-custodial wallet application configured for managing cryptographic keys associated with user-held assets on the client device.

Policy threshold module 204 functions to establish, at the client device, a policy threshold condition within the non-custodial wallet to facilitate rule-based control over transactions involving the user-held assets.

Configuration module 206 functions to enable, at the client device, a user of the non-custodial wallet to define and configure rules governing the spending of the user-held assets, the rules including predefined conditions for transaction approval.

Verification module 208 functions to verify the rules independently at both the client device and a server backend for the non-custodial wallet application during a transaction initiation process, wherein the server backend hosts verification code for the rules;

Transaction request module 210 functions to initiate, at the client device, a transaction request involving the user-held assets, subject to the predefined conditions.

Authorization module 212 functions to transmit the transaction request to the server backend for rule verification, the server backend performing an authorization process based on the rules without signing the transaction.

Transmitting module 214 functions to transmit, in response to successful rule verification at the server backend, a secure portion of a cryptographic key from the server backend to the client device, the secure portion enabling cryptographic transaction signing.

Such functions will be described in further detail below.

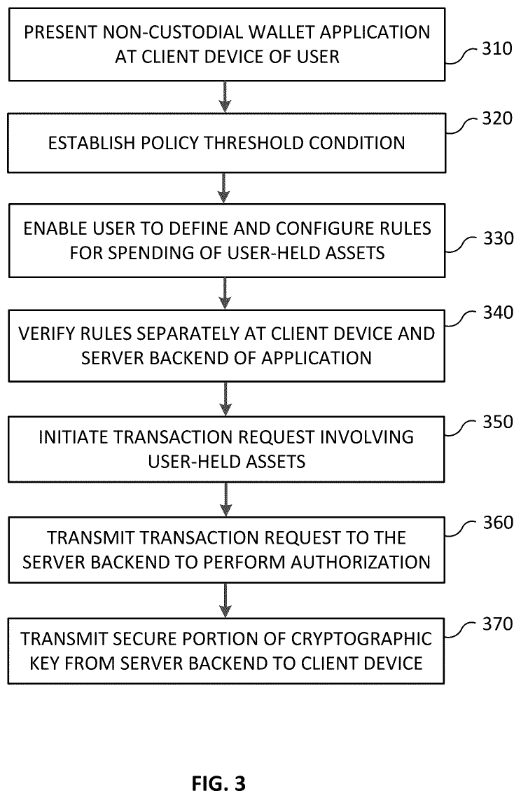

FIG. 3 is a flow chart illustrating an exemplary method that may be performed in some embodiments.

At step 310, the system presents, at a client device associated with a user, a user interface for a non-custodial wallet application configured for managing cryptographic keys associated with user-held assets on the client device.

A non-custodial wallet application, as described herein, refers to a digital software platform designed to empower users with direct control over their cryptographic assets, typically in the form of, e.g., cryptocurrencies, tokens, or digital assets. Unlike custodial wallets, which rely on third-party entities to hold and manage users' private keys and assets, a non-custodial wallet application ensures that users maintain sole ownership and control over their cryptographic keys, allowing them to transact and manage their assets directly without intermediaries.

The non-custodial wallet application operates as a secure and user-friendly interface that resides on a client device, such as, e.g., a smartphone, tablet, or computer. This application provides users with a portal to access, monitor, and manage their cryptocurrency holdings. The key distinction of a non-custodial wallet lies in its emphasis on individual security and control. Users generate and securely store their private keys within the application, enabling them to digitally sign transactions and authenticate ownership without sharing sensitive information with external parties.

In some embodiments, the non-custodial wallet application includes functionalities beyond basic transaction capabilities. In various embodiments, these functionalities may encompass the ability to, for example, view transaction histories, monitor asset balances, configure transaction rules, and engage in decentralized applications directly from the application interface.

The non-custodial wallet application is designed to provide users with a secure and user-friendly interface for managing their cryptographic assets on a client device. The client device, which may be, e.g., a smartphone, tablet, or personal computer, is associated with a specific user and serves as a portal to access and control the non-custodial wallet application. This application is meticulously crafted to enable users to efficiently manage their cryptographic keys, allowing them to retain control over their assets while simplifying the transaction process.

Upon launching the non-custodial wallet application on the client device, the user is presented with a user interface. This interface serves as the gateway to the user's cryptocurrency holdings and facilitates various actions related to asset management. The user interface is optimized to provide a seamless experience for users with varying levels of technical expertise, aligning with the inventor's appreciation for user-centric design.

In various embodiments, the user interface includes essential features such as, e.g., balance displays, transaction histories, and account settings. In some embodiments, users can easily navigate through their cryptocurrency holdings, view recent transactions, and monitor their asset balances in real time. In some embodiments, the interface also enables users to access their cryptographic keys securely, ensuring that users maintain sole control over their assets. This access to cryptographic keys is an essential aspect of non-custodial wallets, allowing users to engage in secure and self-directed transactions.

In some embodiments, the user interface facilitates the configuration of rules governing the spending of user-held assets. In some embodiments, user-defined rules are enabled, or required, for transaction approval and the establishment of predefined conditions. By enabling users to define and customize rules, the invention empowers users to tailor their non-custodial wallet experience to their unique preferences and security requirements. In some embodiments, the user interface guides users through the rule-setting process.

In some embodiments, the user-held assets include cryptocurrency assets, and the non-custodial wallet application is specifically configured for managing transactions involving cryptocurrency holdings. The term “cryptocurrency assets” encompasses a wide array of digital assets built on various blockchain networks. These assets hold intrinsic value and can be transferred or traded within their respective blockchain ecosystems. Such cryptocurrency assets may include, for example, Bitcoin (“BTC”), Ethereum (“ETH”), and Ripple (“XRP”).

At step 320, the system establishes, at the client device, a policy threshold condition within the non-custodial wallet to facilitate rule-based control over transactions involving the user-held assets. This policy threshold condition relates to the invention's rule-based transaction control mechanism, which empowers users to define and customize rules governing the spending of their user-held assets.

In some embodiments, upon opening the non-custodial wallet application on the client device, users are presented with the opportunity to establish a policy threshold condition. This policy threshold condition serves as a predetermined level of authorization that transactions must meet to be executed. The policy threshold condition acts as a safeguard, ensuring that transactions align with the user's predefined criteria before they are processed. This step enhances security and control by allowing users to set specific parameters that must be satisfied for a transaction to be approved.

In some embodiments, the process of defining the policy threshold condition involves user input through the application's user interface. In various embodiments, users can determine conditions such as, e.g., maximum transaction amounts, transaction frequency limits, whitelist addresses, or other rule-based criteria. For example, a user may set a daily spending limit for their assets or create a rule to restrict transactions to specific addresses. By establishing these rules, users are equipped with a comprehensive tool to manage and customize their transaction activities based on their unique preferences and security concerns.

At step 330, the system enables, at the client device, a user of the non-custodial wallet to define and configure rules governing the spending of the user-held assets, the rules including predefined conditions for transaction approval. These rules encompass a wide array of conditions and criteria that users can customize to shape the behavior of their cryptocurrency transactions, ensuring a highly tailored and secure experience.

In some embodiments, upon accessing the non-custodial wallet application on the client device, the user interface guides users through the process of defining and configuring transaction rules. Users have the freedom to establish rules that reflect their specific preferences and requirements, enhancing their control over their financial activities within the cryptocurrency ecosystem. In some embodiments, the rules set by users include predefined conditions that must be met for transactions to receive approval. In various embodiments, these predefined conditions can encompass various aspects, such as, e.g., transaction amounts, recipient addresses, transaction types, spending limits, and more. For example, a user might configure a rule that restricts large transactions during specific time periods or a rule that requires multi-factor authentication for transactions exceeding a certain amount.

In some embodiments, the process of defining and configuring rules takes place directly within the non-custodial wallet application's interface on the client device. In some embodiments, users are prompted to select rule parameters and criteria through one or more UI elements, such as, e.g., dropdown menus, checkboxes, and/or text fields.

In some embodiments, the predefined conditions include a policy threshold condition that establishes the required level of authorization for executing transactions involving the user-held assets. In some embodiments, the policy threshold condition acts as a dynamic authorization criterion within the non-custodial wallet application. It serves as a response to the varied risk appetites and transactional preferences of users. By stipulating a required level of authorization, this condition dictates the minimum threshold that a transaction must fulfill to proceed. This threshold can be set by the user based on factors such as the transaction amount, recipient, or contextual conditions.

In some embodiments, the policy threshold condition ensures transactions meet the prescribed authorization level before proceeding. For example, transactions falling below the required threshold are flagged, and users can be prompted to confirm their intention to proceed with the transaction.

In various embodiments, the policy threshold condition can be manifested in various ways. For example, a user might set a policy threshold that necessitates multi-factor authentication for transactions above a certain amount. Alternatively, the threshold could be defined based on transaction frequency or recipient identity. Such embodiment variations enable users to tailor their wallet's authorization process to their specific preferences.

At step 340, the system verifies the rules independently at both the client device and a server backend for the non-custodial wallet application during a transaction initiation process, wherein the server backend hosts verification code for the rules. This process involves independent verification at both the client device and a dedicated server backend. The server backend, which hosts the verification code for the rules, plays a pivotal role in ensuring the validity and security of transactions initiated by users.

In some embodiments, as a transaction is initiated within the non-custodial wallet application on the client device, the defined rules are subjected to a stringent verification process. This verification occurs in parallel at two distinct points: the client device and the server backend. The aim is to enhance security by confirming that the transaction adheres to the predetermined rules from multiple angles, preventing potential manipulation or unauthorized activities. In some embodiments, the server backend hosts the verification code responsible for evaluating the transaction against the defined rules. This verification code operates independently of the client device, establishing an additional layer of validation. The server backend's role in hosting this verification code ensures that it remains secure, updated, and tamper-resistant. This separation of verification processes between the client device and the server backend bolsters the overall integrity of the transaction validation.

In some embodiments, the system synchronizes the rules between the client device and the server backend, thereby enabling rule changes to be exclusively applied through the client device. This entails the synchronization of rules governing user transactions, maintaining consistency between the client device and the server backend. Moreover, it grants users the capability to exclusively effectuate changes to these rules through the client device, establishing a unidirectional control mechanism. In some embodiments, synchronizing rules guarantees that the rules governing user-held assets remain coherent across both the client device and the server backend. This serves to bridge potential gaps that might arise due to, e.g., network latency or other environmental factors, ensuring that users operate within a cohesive rule framework regardless of their access point.

In some embodiments, the system restricts rule changes to the client device. This guarantees that users hold the exclusive authority to alter the rules governing their transactions. Such a setup prevents unauthorized modifications through external channels and relegates rule adjustments to the user's personal device.

In some embodiments, the user's ability to enact rule changes solely through their client device serves as a practical security measure. For instance, if a user decides to modify a rule related to daily transaction limits, they would do so exclusively via their personal device. This setup ensures that any attempts at rule alteration are confined to the user's trusted environment.

In some embodiments, the system enforces the policy threshold condition to ensure secure and customizable transactions involving the user-held assets within the non-custodial wallet application. This serves to introduce an additional layer of security and customization. This embodiment focuses on the enforcement of the policy threshold condition, augmenting the non-custodial wallet application's functionality to guarantee secure and customizable transactions involving user-held assets. In some embodiments, users are granted the ability to define the policy threshold condition according to their unique preferences and risk tolerance. For example, a user might stipulate a transaction threshold beyond which multi-factor authentication is mandatory. Another user might set a policy that requires their approval for all transactions exceeding a specific amount. These customizable conditions grant users the power to tailor the wallet application to their specific security requirements.

Potential embodiments could also extend to, for example, the incorporation of biometric authentication, time-based transaction limits, or location-based verification. Each of these examples illustrates the manner in which the policy threshold condition can be wielded to align with the user's desired security and customization parameters.

In some embodiments, the non-custodial wallet application includes a secure authentication mechanism for verifying the identity of the user before allowing access to cryptographic keys and transaction functionalities. In some embodiments, the secure authentication mechanism serves as a safeguard against unauthorized access to the application's core functionalities, which include cryptographic key management and transaction initiation. In some embodiments, the system ensures that only authorized individuals with valid credentials can access the application.

At step 350, the system initiates, at the client device, a transaction request involving the user-held assets, subject to the predefined conditions. These transaction requests are subject to the predefined conditions that users have configured within the application.

In some embodiments, upon navigating to the desired transaction within the non-custodial wallet application's user interface on the client device, users input the transaction details such as, e.g., the recipient address, transaction amount, and any additional information required for the specific blockchain network. With the transaction details provided, the user initiates the transaction request, signaling their intent to transfer or utilize their cryptocurrency assets in accordance with the specified parameters.

In some embodiments, at this juncture, the predefined conditions for transaction approval are taken into account by the system. The system evaluates the predefined conditions, which users have configured based on their individual preferences, against the transaction request. These conditions serve as a safety net, ensuring that the transaction aligns with the user's predefined criteria. For instance, in some embodiments, a predefined condition might dictate that, e.g., transactions exceeding a certain amount require multi-factor authentication, or that specific addresses must be whitelisted for transactions to proceed.

In some embodiments, the transaction initiation process is accompanied by real-time validation against these predefined conditions. This validation occurs both on the client device and, as previously described, on the server backend. This dual-layer verification approach guarantees that transactions adhere to the rules set by the user and helps prevent transactions that could potentially breach the established criteria.

At step 360, the system transmits the transaction request to the server backend for rule verification, the server backend performing an authorization process based on the rules without signing the transaction. In some embodiments, this server backend hosts the verification code responsible for evaluating the transaction request against the predefined conditions established by the user. The server backend ensures the validity and adherence of transactions to the user-defined rules.

In some embodiments, upon receiving the transaction request, the server backend begins the rule verification process. In some embodiments, the verification process involves analyzing the transaction details, such as, e.g., the recipient address, transaction amount, and any additional parameters, against the predefined conditions set by the user. In some embodiments, the server backend's verification algorithm rigorously examines whether the transaction meets the criteria specified in the rules, thereby determining whether the transaction should be authorized or denied.

The server backend performs the authorization process based solely on the rules and predefined conditions without actually signing the transaction. This means that the server backend validates the transaction's adherence to the user-defined criteria but does not execute the transaction itself. By abstaining from transaction signing, the server backend maintains the separation of duties, focusing exclusively on rule validation without gaining the capability to manipulate or engage in the transaction.

The server backend's role in rule verification further strengthens the transactional security and integrity within the non-custodial wallet application. By independently evaluating the transaction against the rules, the server backend provides an additional layer of validation that complements the verification process taking place on the client device. This dual-layer verification approach ensures a comprehensive assessment of the transaction's compliance with the predefined conditions.

At step 370, the system transmits, in response to successful rule verification at the server backend, a secure portion of a cryptographic key from the server backend to the client device, the secure portion enabling cryptographic transaction signing. This secure portion of the cryptographic key is a crucial element that enables the client device to perform cryptographic transaction signing, ensuring the secure execution of authorized transactions.

In some embodiments, following the thorough rule verification process conducted by the server backend, if the transaction is found to comply with the predefined conditions, the server backend proceeds to generate a secure portion of the cryptographic key. In some embodiments, this secure portion encapsulates the essential cryptographic information required for transaction signing, without revealing the entirety of the private key associated with the user's assets. This security measure safeguards against any potential exposure of sensitive information during the transmission process.

In some embodiments, once the secure portion of the cryptographic key is generated, it is transmitted securely from the server backend to the client device. In some embodiments, this transmission ensures that the client device receives the cryptographic information necessary to digitally sign the authorized transaction. In some embodiments, the secure portion of the key is designed to work in conjunction with the private key held on the client device, enabling the client device to perform the cryptographic signature required for transaction authentication.

In some embodiments, the cryptographic transaction signing process involves the client device utilizing the secure portion of the key, along with the private key held on the device, to create a digital signature unique to the authorized transaction. This signature serves as a cryptographic proof of the transaction's authenticity and the user's authorization, ensuring that the transaction cannot be tampered with or altered during its execution.

In some embodiments, the system records transaction details and behavioral data associated with the user-held assets, wherein the recorded behavioral data contributes to the generation of user-specific non-fungible tokens (hereinafter “NFTs”) representing user activity within the non-custodial wallet application. In some embodiments, this process represents a mechanism for recording and harnessing user transaction details and behavioral data associated with user-held assets. In some embodiments, this recorded behavioral data additionally contributes to the generation of user-specific NFTs that encapsulate and symbolize user activity within the non-custodial wallet application.

The concept revolves around the recording of transaction details and behavioral patterns as users navigate their cryptocurrency transactions. In various embodiments, this recorded data could encompass a wide spectrum of user interactions, such as, for example, the types of assets transacted, transaction frequency, spending patterns, and even the contextual factors that influence transaction decisions. In some embodiments, the recorded behavioral data serves as a foundational resource for the generation of user-specific NFTs. These tokens are unique digital assets that represent a user's distinct behavioral patterns and activities within the non-custodial wallet application.

For example, a user may frequently engage in microtransactions for gaming purposes within the non-custodial wallet application. The recorded behavioral data might encompass the precise times of these transactions, the games involved, and the corresponding assets exchanged. This data could then be processed and transformed into an NFT that visually symbolizes the user's gaming activity. Such NFTs could hold both intrinsic and extrinsic value, making them collectible and tradable.

In some embodiments, users could potentially own a gallery of NFTs that visually narrate, for example, their financial journey, transactional preferences, and engagement with different aspects of the non-custodial wallet application. Furthermore, in some embodiments, NFTs generated from transactional data could serve as unique attestations of user behavior, granting users a tangible record of their cryptocurrency interactions.

In some embodiments, the cryptographic key is securely decrypted on the client device using user-specific authentication credentials before signing the transaction. This addresses the process by which the cryptographic key is decrypted and transaction signing is initiated within the non-custodial wallet application. In some embodiments, when a transaction is initiated and the policy threshold condition is met, the cryptographic key required for transaction signing is securely retrieved from the server backend. In some embodiments, this key is decrypted exclusively on the client device. In some embodiments, this decryption process is fortified with the utilization of user-specific authentication credentials.

In some embodiments, user-specific authentication credentials refer to the unique combination of factors that authenticate the user's identity and grant access to their account. These credentials often include, e.g., passwords, biometric verification (such as fingerprints or facial recognition), and other multi-factor authentication methods. Without the user-specific authentication credentials, the key remains encrypted and impervious to potential breaches. Furthermore, the secure decryption process mitigates the risk associated with potential device theft or unauthorized access. Even if the client device falls into the wrong hands, the encrypted cryptographic key remains inaccessible without the requisite user-specific authentication credentials.

In some embodiments, the non-custodial wallet application operates across various blockchain networks, enabling the customization of transactions on a wide range of blockchain-based assets. The term “operates across various blockchain networks” underscores the application's proficiency in engaging with different blockchain ecosystems, each characterized by its distinct protocols, assets, and transaction mechanisms.

In some embodiments, the application is able to customize transactions on a wide range of blockchain-based assets. This capability taps into the inherent diversity of blockchain networks and their corresponding assets, encompassing, e.g., cryptocurrencies, tokens, and other digital assets that reside within disparate ecosystems. In some embodiments, a multi-blockchain approach to transaction customization is applied, signifying that users can tailor rules, policies, and transaction parameters across the spectrum of blockchain networks. Users can define and configure rules that are optimized for each specific blockchain asset, accounting for nuances in transaction confirmation times, fee structures, and governance mechanisms unique to each blockchain.

Potential embodiments could involve the customization of transaction policies for assets such as, for example, Bitcoin, Ethereum, Ripple, and numerous other blockchain-based tokens. For instance, a user might configure a rule for faster transaction confirmation on a blockchain with rapid confirmation times, while applying a different rule on a blockchain with longer confirmation intervals.

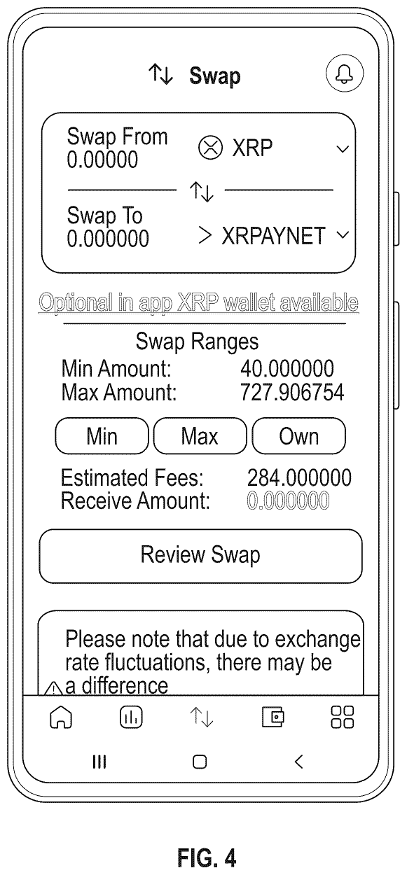

FIG. 4 is a diagram illustrating a user interface for the digital non-custodial wallet application that facilitates rule-based control over transactions involving user-held assets. The user interface allows for a streamlined way for a user to navigate rule-based control over transactions involving user-held assets. The diagram illustrates a “Swap” screen within the non-custodial wallet application. The swap functionality presented enables a user to swap cryptocurrencies in a way that adheres to the user's personally tailored rules.

The “Swap” interface showcases user-defined rules in action. The presented swap ranges harmonize the established policy threshold conditions with user preferences, offering a dynamic range within which to transact. The diagram illustrates current minimum and maximum amounts—40.000000 to 727.906754—which factor in both default swap ranges of the cryptocurrencies, and any rules which are applied to control and limit cryptocurrency transaction amounts.

Upon a user interacting with the “Review Swap” button, a transaction request is initiated on the client device, and is verified separately at both the client device and the server backend. A secure portion of a cryptographic key is transmitted. This secure transmission bridges the domains of client device and server backend, empowering the client device to sign transactions in a cryptographically secure fashion.

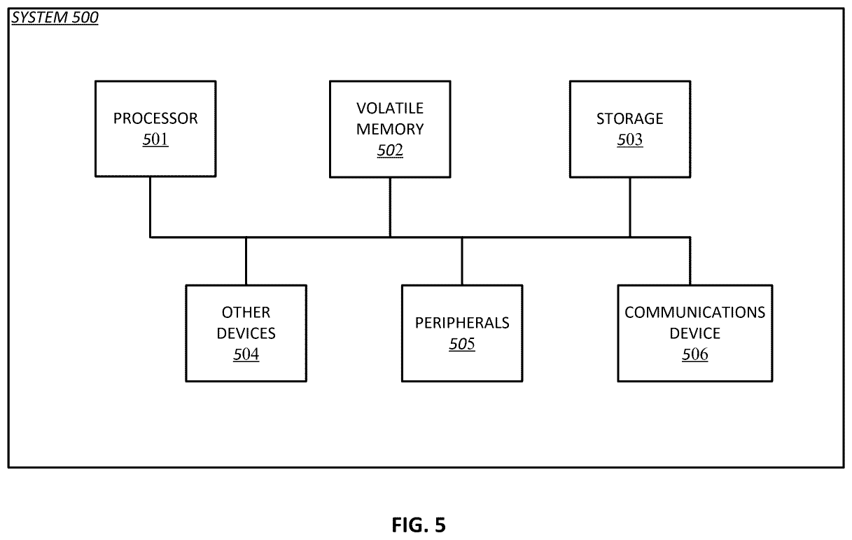

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for facilitating a non-custodial wallet application at a client device, comprising:
presenting, at a client device associated with a user, a user interface for a non-custodial wallet application configured for managing cryptographic keys associated with user-held assets on the client device;
establishing, at the client device, a policy threshold condition within the non-custodial wallet to facilitate rule-based control over transactions involving the user-held assets;
enabling, at the client device, a user of the non-custodial wallet to define and configure rules governing the spending of the user-held assets, the rules including predefined conditions for transaction approval;
verifying the rules independently at both the client device and a server backend for the non-custodial wallet application during a transaction initiation process, wherein the server backend hosts verification code for the rules;
initiating, at the client device, a transaction request involving the user-held assets, subject to the predefined conditions;
transmitting the transaction request to the server backend for rule verification, the server backend performing an authorization process based on the rules without signing the transaction; and
in response to successful rule verification at the server backend, transmitting a secure portion of a cryptographic key from the server backend to the client device, the secure portion enabling cryptographic transaction signing.

2. The method of claim 1, wherein the predefined conditions include a policy threshold condition that establishes the required level of authorization for executing transactions involving the user-held assets.

3. The method of claim 1, further comprising:
recording transaction details and behavioral data associated with the user-held assets, wherein the recorded behavioral data contributes to the generation of user-specific non-fungible tokens (NFTs) representing user activity within the non-custodial wallet application.

4. The method of claim 1, further comprising:
synchronizing the rules between the client device and the server backend, and enabling rule changes to be exclusively applied through the client device.

5. The method of claim 1, further comprising:
enforcing the policy threshold condition to ensure secure and customizable transactions involving the user-held assets within the non-custodial wallet application.

6. The method of claim 1, wherein the cryptographic key is securely decrypted on the client device using user-specific authentication credentials before signing the transaction.

7. The method of claim 1, wherein the non-custodial wallet application operates across various blockchain networks, enabling the customization of transactions on a wide range of blockchain-based assets.

8. The method of claim 1, wherein the user-held assets comprise cryptocurrency assets, and the non-custodial wallet application is specifically configured for managing transactions involving cryptocurrency holdings.

9. The method of claim 1, wherein the non-custodial wallet application further comprises a secure authentication mechanism for verifying the identity of the user before allowing access to cryptographic keys and transaction functionalities.

10. The method of claim 1, further comprising:
providing a user interface within the non-custodial wallet application to enable the user to define and configure rules.

11. The method of claim 1, wherein the server backend performs additional security checks and fraud prevention measures to detect and prevent unauthorized or fraudulent transactions.

12. The method of claim 1, further comprising:
enabling users to generate, manage, and restore cryptographic key backups securely, ensuring access to assets even in the event of device loss or failure.

13. The method of claim 1, wherein the non-custodial wallet application supports multi-signature transactions, allowing multiple authorized parties to collectively approve and execute transactions involving user-held assets.

14. A system for facilitating a non-custodial wallet application at a client device, the system comprising one or more processors configured to perform the operations of:
presenting, at a client device associated with a user, a user interface for a non-custodial wallet application configured for managing cryptographic keys associated with user-held assets on the client device;
establishing, at the client device, a policy threshold condition within the non-custodial wallet to facilitate rule-based control over transactions involving the user-held assets;
enabling, at the client device, a user of the non-custodial wallet to define and configure rules governing the spending of the user-held assets, the rules including predefined conditions for transaction approval;
verifying the rules independently at both the client device and a server backend for the non-custodial wallet application during a transaction initiation process, wherein the server backend hosts verification code for the rules;
initiating, at the client device, a transaction request involving the user-held assets, subject to the predefined conditions;
transmitting the transaction request to the server backend for rule verification, the server backend performing an authorization process based on the rules without signing the transaction; and
in response to successful rule verification at the server backend, transmitting a secure portion of a cryptographic key from the server backend to the client device, the secure portion enabling cryptographic transaction signing.

15. The system of claim 14, wherein the predefined conditions include a policy threshold condition that establishes the required level of authorization for executing transactions involving the user-held assets.

16. The system of claim 14, wherein the one or more processors are further configured to perform the operation of:
recording transaction details and behavioral data associated with the user-held assets, wherein the recorded behavioral data contributes to the generation of user-specific non-fungible tokens (NFTs) representing user activity within the non-custodial wallet application.

17. The system of claim 14, wherein the one or more processors are further configured to perform the operation of:
synchronizing the rules between the client device and the server backend, and enabling rule changes to be exclusively applied through the client device.

18. The system of claim 14, wherein the one or more processors are further configured to perform the operation of:
enforcing the policy threshold condition to ensure secure and customizable transactions involving the user-held assets within the non-custodial wallet application.

19. The system of claim 14, wherein the cryptographic key is securely decrypted on the client device using user-specific authentication credentials before signing the transaction.

20. A non-transitory computer-readable medium containing instructions for facilitating a non-custodial wallet application at a client device, comprising:
instructions for presenting, at a client device associated with a user, a user interface for a non-custodial wallet application configured for managing cryptographic keys associated with user-held assets on the client device;
instructions for establishing, at the client device, a policy threshold condition within the non-custodial wallet to facilitate rule-based control over transactions involving the user-held assets;
instructions for enabling, at the client device, a user of the non-custodial wallet to define and configure rules governing the spending of the user-held assets, the rules including predefined conditions for transaction approval;
instructions for verifying the rules independently at both the client device and a server backend for the non-custodial wallet application during a transaction initiation process, wherein the server backend hosts verification code for the rules;
instructions for initiating, at the client device, a transaction request involving the user-held assets, subject to the predefined conditions;
instructions for transmitting the transaction request to the server backend for rule verification, the server backend performing an authorization process based on the rules without signing the transaction; and
in response to successful rule verification at the server backend, instructions for transmitting a secure portion of a cryptographic key from the server backend to the client device, the secure portion enabling cryptographic transaction signing.
